(19) United States
(12) Patent Application Publication
(10) Pub. No.: US 2015/0096182 A1
(43) Pub. Date: Apr. 9, 2015

(54) Welder's Work Piece Positioning and Leveling Tool

(71) Applicant: Mark L. Silberberg, Fallbrook, CA (US)

(72) Inventor: Mark L. Silberberg, Fallbrook, CA (US)

(21) Appl. No.: 14/045,577

(22) Filed: Oct. 3, 2013

(51) Int. Cl. G01C 9/36

(52) U.S. Cl. CPC G01C 9/36; G01C 2009/187
USPC 33/381

(57) ABSTRACT

A specially designed welder's work piece positioning and leveling tool that includes a plurality of strategically oriented work piece positioning surfaces provided on the tool body for holding and correctly positioning work pieces to be welded together. The tool also includes a plurality of differently oriented bubble vials that are secured within the tool body in a manner such that, if any one of the bubble vials become broken, or otherwise damaged, it can be easily replaced and the level need not be discarded.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to tools used in the construction industry. More particularly, the invention concerns a specially designed welder's work positioning and leveling tool having replaceable bubble vials and including strategically located magnets for holding and correctly positioning the work pieces that are to be welded together.

2. Description of Related Art Including Information Disclosed Under 37 CRF 1.97 and 1.98

Bubble levels of various designs have been suggested in the past and are widely used by construction workers to determine the orientation of a particular structure or surface with respect to a reference axis. A typical bubble level generally comprises an elongated body that has a pair of opposing, generally parallel working surfaces and includes a plurality of openings having bubble vials permanently secured therein. The bubble vials are typically aligned in different directions relative to the working surfaces and function to indicate the orientation of a structure. For example, one vial may be aligned in a direction perpendicular to the working surfaces, another may be aligned in a direction parallel to the working surfaces and a third may be aligned in an angular direction. Typically, the vial contains a fluid and a bubble, and the user views the position of the bubble within the vial to determine the position of the tool relative to the working surfaces.

A novel and highly useful level construction is disclosed in U.S. Pat. No. 7,802,372 issued to the present inventor. This patent, which is entitled “Removable Laser Base Attachment for Bubble Levels”, describes a bubble level that includes a body, a laser beam generator, and a removable securement. The body has a flat top surface that the level is secured to and a bottom surface that is flat and parallel to the top surface. A laser diode mounted in a module emits a visible laser beam upon application of power from a battery that is controlled by a switch. The module, batteries, and switch are mounted in a through bore in the body. The laser base is removably secured to the bubble level by any manner appropriate to the shape of the level. In one such securement, the level has a T-shaped cross-section and the body has a complementary slot into which the level slides. When the level reference surface abuts the top surface of the laser base, a thumb screw is tightened to frictionally secure the level in the base.

### BRIEF SUMMARY OF THE INVENTION

It is an object of the present invention to provide a specially designed welder's work piece positioning and leveling tool. The tool includes a plurality of strategically oriented work piece positioning surfaces provided on the tool body for holding and correctly positioning work pieces to be welded together. Additionally, the tool includes a plurality of differently oriented bubble vials that are secured within the tool body in a manner such that, if any one of the bubble vials become broken, or otherwise damaged, it can be easily replaced and the level need not be discarded.

Another object of the invention is to provide a tool of the afore mentioned character in which each of the work piece positioning surfaces are provided with a plurality of longitudinally spaced magnets that function to securely hold the work pieces to be welded together in the proper orientation for welding and also function to permit the tool to be conveniently, removably connected to any ferrous structure that is being leveled.

Another object of the invention is to provide a tool of the character described in the preceding paragraph in which the bubble vials are securely held in position within threaded chambers formed in the level body by easily removable threaded cap screws.

Another object of the invention is to provide a tool of the character described in the preceding paragraphs which includes a bulls-eye level that is mounted on the top surface of the tool body proximate the center thereof.

Still another object of the invention is to provide a welder's tool of the class described that includes an elongate body having a recessed central portion that is circumscribed by outwardly extending, transversely spaced apart first and second flanges, or rims, that advantageously permit a welder wearing heavy welding gloves to securely grip and manipulate the tool.

Yet another object of the invention is to provide a welder's tool and leveling device of the type described in which each of the top, bottom and end work positioning surfaces of the tool includes a centrally disposed, generally V-shaped groove for longitudinally centering tubular shaped workpieces.

These and other objects of the invention will be realized by the level construction illustrated in the drawings and described in the paragraphs that follow.

### BRIEF DESCRIPTION OF SEVERAL VIEWS OF THE DRAWINGS

FIG. 1 is a side elevational view of one form of the welder's work piece positioning and leveling tool of the invention.

FIG. 2 is a right end view of the leveling device shown in FIG. 1.

FIG. 3 is a left end view of the leveling device shown in FIG. 1.

FIG. 4 is a top plan view of the leveling device shown in FIG. 1.

FIG. 5 is a bottom plan view of the leveling device shown in FIG. 1.

FIG. 6 is a cross-sectional view taken along lines 6-6 of FIG. 4.

FIG. 6A is a cross-sectional view taken along lines 6A-6A of FIG. 6.

FIG. 7 is a generally diagrammatic, side elevational view of the leveling device of the invention illustrating the positioning of one set of the work pieces to be welded together at a first angle.

FIG. 8 is a generally diagrammatic side elevational view of the leveling device of the invention illustrating the positioning of a second set of the work pieces to be welded together at a second angle.

### DETAILED DESCRIPTION OF THE INVENTION

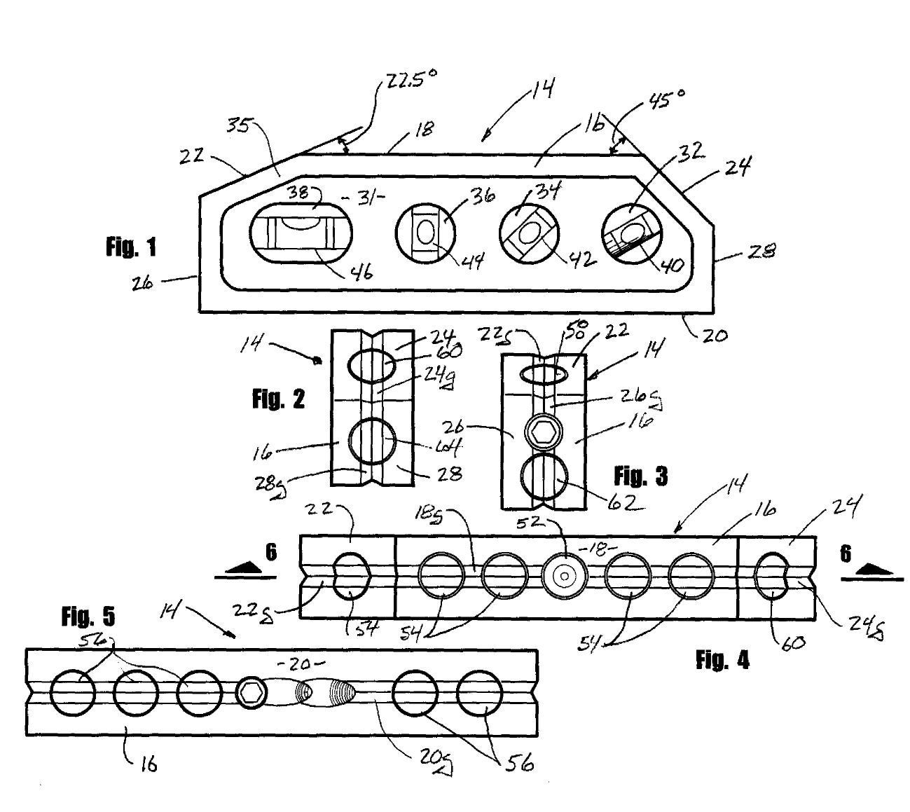

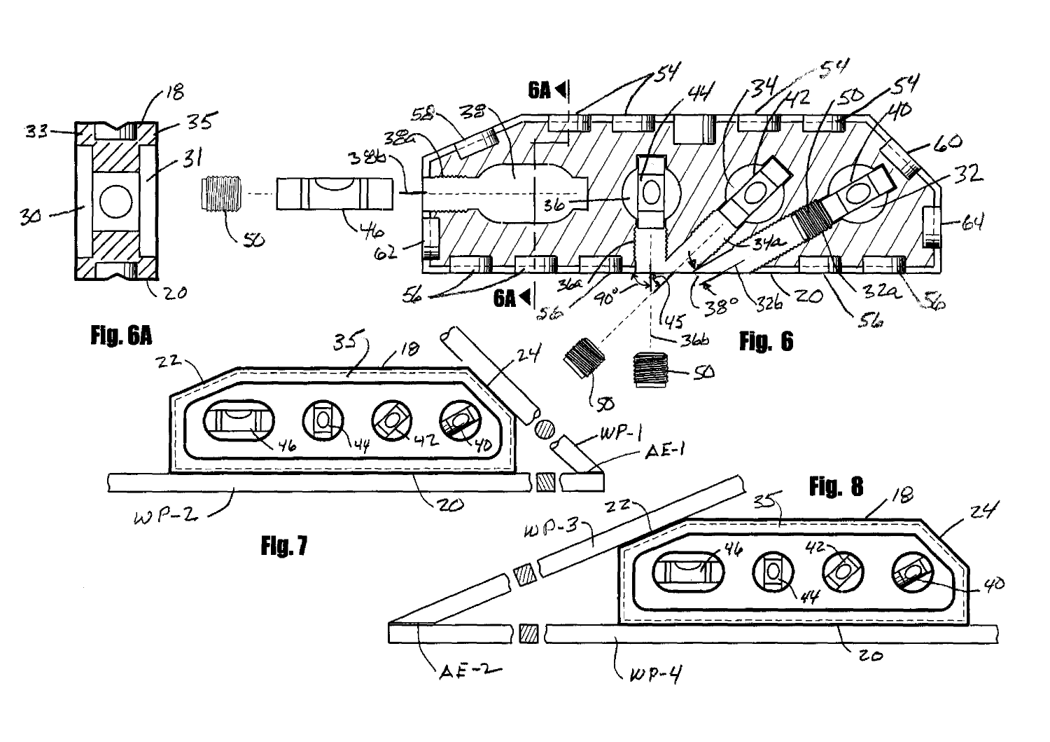

Referring to the drawings and particularly to FIGS. 1 through 6A, one form of the welder's work piece positioning and leveling tool of the invention is there shown and generally designated by the numeral 14. Positioning tool 14 here comprises an elongate body 16 having a top work positioning surface 18, a work positioning bottom surface 20 and first and second angled work positioning end surfaces 22 and 24, respectively. In the tool of the present invention, first end surface 22 extends at an angle of approximately 22.5 degrees with respect to top surface 18 while end surface 24 extends at an angle of approximately 45 degrees with respect to top surface 18. Elongate body 16 also includes work positioning end surfaces 26 and 28 that extend generally perpendicularly with respect to bottom work positioning surface 20. As best seen in FIG. 6A, elongate body 16 has recessed, transversely spaced apart central portions 30 and 31 that are circumscribed by outwardly extending, transversely spaced apart first and second flanges 33 and 35 (FIG. 6A) that, along with the central portion of the tool, define the top, bottom and end surfaces 18, 20, 22, 24, 26 and 28 respectively. Advantageously, flanges, or rims 33 and 35 extend outwardly from the central portion the tool a sufficient distance to permit a welder wearing heavy welding gloves to securely grip and manipulate the tool.

For a reason presently to be described, each of the top, bottom and end surfaces 18, 20, 22, 24, 26 and 28 of the tool is provided with a centrally disposed, generally V-shaped groove which is identified in the drawings by the designations 18g, 20g, 22g, 24g, 26g, and 28g respectively.

As best seen in FIGS. 1 and 6 of the drawings, body 16 has a plurality of differently oriented vial chambers 32, 34, 36 and 38. Vial chamber 32 has a threaded portion 32a and a central axis 26b that is disposed at an angle of approximately 38 degrees with respect to bottom surface 20 (see FIG. 6). Vial chamber 34 has a threaded end portion 34a and a central axis 34b that is disposed at an angle of approximately 45 degrees with respect to bottom surface 20. Vial chamber 36 has a threaded end portion 36a and a central axis 36b that is disposed at an angle of approximately 90 degrees with respect to bottom surface 20. Vial chamber 38 has a threaded end portion 38a and a central axis 38b that is disposed in a generally parallel relationship with bottom surface 20. It is to be understood that the angles of the axes of the central axis of each of the vial chambers can vary depending upon the end use of the improved level.

A conventional bubble vial 40 is disposed within vial chamber 32 and is uniquely removably secured there within by a threaded connector that is threadably receivable within threaded opening 32a of vial chamber 32. The threaded connector, which is here provided in the form of a conventional cap screw 50 (FIG. 6), is moveable between first and second positions to secure the bubble vial 40 within vial chamber 32 (FIG. 1). A conventional bubble vial 42 is disposed within vial chamber 34 and is uniquely removably secured there within by a threaded connector that is threadably receivable within threaded opening 34a of vial chamber 34. The threaded connector, which is also here provided in the form of a conventional cap screw 50 (FIG. 6), is moveable between first and second positions to secure the bubble vial 42 within vial chamber 34 (FIG. 1). In similar manner, a conventional bubble vial 44 is disposed within vial chamber 36 and is uniquely removably secured there within by a threaded connector that is threadably receivable within threaded opening 36a of vial chamber 36. Once again, the threaded connector is provided in the form of a conventional cap screw 50 that is moveable between first and second positions to secure the bubble vial 44 within vial chamber 36 (FIG. 1). In like manner, as shown in FIG. 1, a conventional bubble vial 46 is disposed within vial chamber 38 and is removably secured there within by a conventional cap screw 50 (FIG. 6) which is moveable between first and second positions to secure the bubble vial 40 within vial chamber 32. As illustrated in FIG. 4 of the drawings, top surface 18 is provided with a centrally located, conventional bulls eye level 52.

As illustrated in the drawings, each of the top, bottom and end surfaces of the level 18, 20, 22, 24, 26 and 28 is provided with at least one generally cylindrically shaped magnet that is bisected by the V-shaped groove. More particularly top surface 18 is provided with four longitudinally spaced magnets 54, while bottom surface 20 is provided with five longitudinally spaced magnets 56. End surface 22 is provided with a magnet 58, end surface 24 is provided with a magnet 60, end surface 26 is provided with a magnet 62 and end surface 28 is provided with a magnet 64. The purpose of these magnets will presently be described.

Turning particularly to FIGS. 7 and 8 of the drawings, the manner of use of the welder's work piece positioning and leveling tool of the invention to position various types of work pieces to be welded together is there illustrated. More particularly, FIG. 7 illustrates the method of the invention for welding together an elongated work piece “WP-1” that is generally cylindrically in cross-section and an elongated work piece “WP-2” that is generally rectangular in cross-section. In order to accomplish the welding step, work piece “WP-1” is positioned in engagement with end surface 24 and work piece “WP-2” is positioned in engagement with bottom surface 20 in a manner such that the angled end “AE-1” engages work piece “WP-2”. Since work piece “WP-1” rests within V groove 24g and in engagement with magnet 60, it is securely held in position in parallel alignment with the flanges 33 and 35 of the tool. Similarly, work piece “WP-2” is positioned in engagement with magnets 56 provided on lower surface 20 and is disposed in parallel alignment with the flanges 33 and 35 of the tool. With the work pieces held in the position thus described, the ends of the work pieces can be welded together at a 45 degree angle in a conventional manner well understood by those skilled in the art. It is to be understood that various types of elongate work pieces of various cross-sectional configurations can be welded together at a precise angle in the manner described.

FIG. 7 illustrates the method of the invention for welding together an elongated work piece “WP-3” that is generally rectangular in cross-section and an elongated work piece “WP-4” that is also generally rectangular in cross-section. In order to accomplish the welding step, work piece “WP-3” is positioned in engagement with end surface 22 and work piece “WP-4” is positioned in engagement with bottom surface 20 in a manner such that the angled end “AE-2” engages work piece “WP-4”. Since work piece “WP-3” is disposed in engagement with magnet 58 it is securely held in position and can be disposed in parallel alignment with the flanges 33 and 35 of the tool. Similarly, work piece “WP-4” is positioned in engagement with magnets 56 provided on lower surface 20 and can be disposed in parallel alignment with the flanges 33 and 35 of the tool. With the work pieces held in the position thus described, the ends of the work pieces can be welded together at an angle of 22.5 degrees in a conventional manner well understood by those skilled in the art. As before, it is to be understood that various types of elongate work pieces of various cross-sectional configurations can be welded together at a precise angle in the manner described.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

1. A work positioning and leveling tool comprising:
(a) a body having a top surface, a bottom surface and first and second end surfaces, at least one of said first and second end surfaces extending at an angle with respect to said top surface, said body having a plurality of vial chambers, each said vial chamber having a threaded opening;
(b) a bubble vial disposed within each of said vial chambers of said body;
(c) a threaded connector receivable within said threaded opening of each of said vial chambers for movement between first and second positions to secure said bubble vials within said vial chambers;
(d) at least one magnet connected to said bottom surface of said body; and
(e) at least one magnet connected to said first end surface of said body.

2. The work positioning and leveling tool as defined in claim 1 further including at least one magnet connected to said second end surface of said body.

3. The work positioning and leveling tool as defined in claim 1 further including a bulls-eye level connected to said top surface of said body.

4. The work positioning and leveling tool as defined in claim 1 in which said threaded connector comprises a cap screw.

5. The work positioning and leveling tool as defined in claim 1 in which each of said top, bottom and first end surfaces is provided with a longitudinally extending, generally V-shaped groove.

6. The work positioning and leveling tool as defined in claim 1 in which each of said top, bottom and first end surfaces is provided with a plurality of spaced apart magnets.

7. The work positioning and leveling tool as defined in claim 1 in which said first end surface of said body extends at an angle of between about 20 degrees and about 45 degrees with respect to said top surface of said body.

8. The work positioning and leveling tool as defined in claim 1 in which at least one of said plurality of vial chambers is disposed at an angle with respect to said top surface of said body.

9. The work positioning and leveling tool defined in claim 1 in which at least one of said plurality of vial chambers is disposed in a parallel relationship with said top surface of said body.

10. A welder's work positioning and leveling tool comprising:
(a) a body having a top surface, a bottom surface and first and second end surfaces, at least one of said first and second end surfaces extending at an angle with respect to said top surface, said body having a plurality of vial chambers, each said vial chamber having a threaded opening;
(b) a bubble vial disposed within each of said vial chambers of said body;
(c) a threaded connector receivable within said threaded opening of each of said vial chambers for movement between first and second positions to secure said bubble vials within said vial chambers;
(d) a plurality of longitudinally spaced magnets connected to said top surface of said body;
(e) a plurality of longitudinally spaced magnets connected to said bottom surface of said body;
(f) at least one magnet connected to said first end surface of said body;
(g) at least one magnet connected to said second end surface of said body; and
(h) a bulls-eye level connected to said top surface of said body.

11. The work positioning and leveling tool as defined in claim 10 in which said threaded connector comprises a cap screw.

12. The work positioning and leveling tool as defined in claim 10 in which each of said top, bottom, first and second end surfaces is provided with a longitudinally extending, centrally disposed generally V-shaped groove.

13. The work positioning and leveling tool as defined in claim 10 in which said first end surface of said body extends at an angle of about 45 degrees respect to said top surface of said body.

14. The work positioning and leveling tool as defined in claim 10 in which said second end surface of said body extends at an angle of about 22.5 degrees respect to said top surface of said body.

15. The work positioning and leveling tool as defined in claim 10 in which at least one of said plurality of vial chambers is disposed at an angle with respect to said top surface of said body.

16. The work positioning and leveling tool defined in claim 10 in which at least one of said plurality of vial chambers is disposed in a parallel relationship with said top surface of said body.

17. The level as defined in claim 10 in which at least one of said plurality of vial chambers is disposed in a substantially perpendicular relationship with said top surface of said body.

18. A welder's work positioning and leveling tool comprising:
(a) a body including a top surface having a longitudinally extending, centrally disposed, generally V-shaped groove, a bottom surface having a longitudinally extending, centrally disposed, generally V-shaped groove and first, second, third and fourth end surfaces, each of said first, second and third and fourth end surfaces having a centrally disposed generally V-shaped groove, at least one of said first and second end surfaces extending at an angle with respect to said top surface, said body having a plurality of vial chambers, each said vial chamber having a threaded opening;
(b) a bubble vial disposed within each of said vial chambers of said body;
(c) a cap screw receivable within said threaded opening of each of said vial chambers for movement between first and second positions to secure said bubble vials within said vial chambers;
(d) a plurality of longitudinally spaced magnets connected to said top surface of said body;
(e) a plurality of longitudinally spaced magnets connected to said bottom surface of said body;
(f) at least one magnet connected to said first end surface of said body;
(g) at least one magnet connected to said second end surface of said body; and
(h) a bulls-eye level connected to said top surface of said body.

19. The work positioning and leveling tool as defined in claim 18 in which said first end surface of said body extends at an angle of about 45 degrees respect to said top surface of said body.

20. The work positioning and leveling tool as defined in claim 18 in which at least one of said plurality of vial chambers is disposed at an angle with respect to said top surface of said body.
